(19) United States
(12) Patent Application Publication
(10) Pub. No.: US 2011/0281514 A1
(43) Pub. Date: Nov. 17, 2011

(54) APPARATUS FOR DIRECTING AIR FLOW IN A BIOLOGICAL SAFETY CABINET

(75) Inventors: Robert Kenneth Haugen, Statesville, NC (US); Arturo Ramos, Statesville, NC (US); Kurt P. Rindoks, Davidson, NC (US)

(73) Assignee: Kewaunee Scientific Corporation, Statesville, NC (US)

(21) Appl. No.: 12/777,948

(22) Filed: May 11, 2010

(51) Int. Cl. B08B 15/02

(52) U.S. Cl. 454/57

(57) ABSTRACT

A biological safety cabinet with several air flow directional control enhancements. A perforated air intake grille within the work chamber inwardly adjacent the user access opening has a forwardly facing make-up air intake surface and a rearwardly facing internal air intake surface angled in converging relation to promote a physical division between intake of ambient air and internal air into the cabinet's air recirculation system. An aerodynamic user arm rest is affixed to a support stand to extend alongside the access opening at a spacing outwardly from the housing to assist in directing make-up air to the ambient air intake opening without cross-contamination between the arm rest and the work chamber. An air transmission grille above the work chamber has a horizontal main extent terminating at a spacing from the sash and an upwardly angled extent adjacent the sash to direct increased laminar air flow downwardly along the sash.

### BACKGROUND OF THE INVENTION

The present invention relates generally to biological safety cabinets and, more particularly, to structural elements of biological safety cabinets by which the flow of air is directed within biological safety cabinets.

Biological safety cabinets provide a biohazard containment means which enable laboratory personnel in diverse industries, e.g., life science, medical, and pharmaceutical industries, to perform various laboratory, experimental and like procedures utilizing biologically hazardous substances while protecting the personnel, the work product and the ambient environment from exposure to and contamination by such substances. Biological safety cabinets are currently certified by the National Sanitation Foundation (NSF) International, of Ann Arbor, Mich., according to three levels of classification. The present invention is particularly applicable to the class of biological safety cabinets referred to as Class II, Type A2 cabinets.

Class II A2 biological safety cabinets basically have a work chamber that is mostly enclosed except for a front access opening sufficient for a user's hands to perform procedures within the work chamber. An air circulation system maintains a continuously circulating positive air flow within the work chamber which is controlled to move laminarly in parallel relation to the front access opening to prevent escape of the internal cabinet air outwardly through the forward access opening to protect the user and the ambient area from contamination. The air circulation system utilizes a fan to continuously withdraw air from the work chamber into an adjacent filtration chamber from which a portion of the air is recirculated into the work chamber through a first high efficiency particulate air filter, commonly referred to as a HEPA filter, while the balance of the withdrawn air is exhausted outside the cabinet through a second HEPA filter. Typically, a ratio of about 70% recirculated air to 30% exhausted air is maintained in Class II A2 cabinets. The exhausted air is replaced by ambient air from the surrounding room drawn first into the filtration chamber before entering the work chamber through the first filter, thereby to prevent room air contamination of the work chamber and also to maintain the integrity of the laminar air flow along the front access opening.

It is important that the laminar character of the internal air flow within the biological safety cabinet is maintained with minimal turbulence. This is especially important in the forward area of the work chamber in the region of the user access opening, as turbulence in the air currents in this region can result in undesirable escape of contaminated internal air outwardly through the access opening, posing a hazard to users and other laboratory personnel, and/or ingress of unfiltered ambient air into the work chamber, posing a risk of contaminating procedures conducted within the work chamber.

Thus, air flow directional control elements are particularly critical in biological safety cabinets for maintaining air flow within the work chamber to move decisively downward along the forward access opening in a laminar manner that does not migrate inward or outward nor leftward or rightward, and for equally constraining the intake of ambient air solely into the filtration system of the cabinet. While all biological safety cabinets seek to meet these operational parameters, it remains a continuing objective in the industry for enhanced reliability in the directional control of air flow into and within the cabinets.

### SUMMARY OF THE INVENTION

The present invention seeks to meet the foregoing objectives in an improved manner over conventional biological safety cabinets. Basically, the present invention provides a biological safety cabinet comprising a housing defining a work chamber, a filtration chamber, and a forward opening into the work chamber for user access. An air recirculation system circulates internal air within and between the work chamber and the filtration chamber in a controlled manner for mitigating escape of circulating internal air from the work chamber and for mitigating ingress of ambient air into the work chamber through the forward opening. The air recirculation system includes a filter between the filtration chamber and the work chamber for removing contaminants from the air before re-entering the work chamber. More specifically, the air recirculation system includes an air exhaust sub-system for discharge of a portion of the internal air from the filtration chamber and an air intake sub-system for directing make-up ambient air into the filtration chamber for replacement of the exhausted internal air, and the air intake sub-system includes an intake opening disposed adjacent the forward opening.

In accordance with one aspect of the invention, the air intake opening of the air recirculation system is formed by a perforated air intake grille disposed within the work chamber inwardly spaced from the forward opening by a flat unperforated wall section, the grille having an asymmetrical angular configuration defining a make-up air intake surface and an internal air intake surface oriented angularly upwardly in converging relation to one another. The make-up air intake surface faces forwardly toward the forward opening for intake therethrough of ambient make-up air and the internal air intake surface faces rearwardly away from the forward opening for intake therethrough of circulating internal air moving downwardly through the work chamber, to promote a physical division between the intake of ambient air and the recirculation of internal air. Advantageously, the flat unperforated wall section may serve as an arm rest area for a technician while working within the work chamber.

According to a further aspect of the present invention, the housing is supported on a stand at an elevation suitable for user access into the work chamber through the forward opening, and a user arm rest is affixed to the support stand extending alongside the forward opening at a spacing outwardly from the housing to avoid the potential for cross-contamination between the arm rest and the work chamber. The arm rest is disposed adjacent the air intake grille at an outward spacing therefrom and has an aerodynamic configuration for assisting in direction of ambient make-up air to the make-up air intake surface. Preferably, the arm rest is of a generally elliptical shape to enhance the aerodynamics of intake air flow thereover.

The housing also includes a transverse air transmission grille between the work chamber and the filtration chamber, and a sash forwardly and downwardly of the grille for defining a forward boundary to the work chamber. According to another aspect of the present invention, the grille has a generally flat main extent terminating at a spacing from the sash and an upwardly angled extent adjacent the sash. Both the main extent and the angled extent of the grille are perforated for passage of internal air circulating through the filter from the filtration chamber into the work chamber, the angled extent of the grille being effective to direct an increased flow of circulating internal air downwardly along the sash to promote laminar flow of the circulating air therealong.

### BRIEF DESCRIPTION OF THE DRAWINGS

FIG. 1 is a partially exploded and partially broken-away perspective view of a biological safety cabinet according to a preferred embodiment of the present invention;

FIG. 2 is a vertical cross-sectional view of the biological safety cabinet of FIG. 1, taken along line 2-2 thereof;

FIG. 3 is another vertical cross-sectional view of the biological safety cabinet of FIG. 1, taken along line 3-3 thereof; and

FIG. 4 is an enlargement of the area 4 in the cross-section of FIG. 2.

### DETAILED DESCRIPTION OF THE PREFERRED EMBODIMENTS

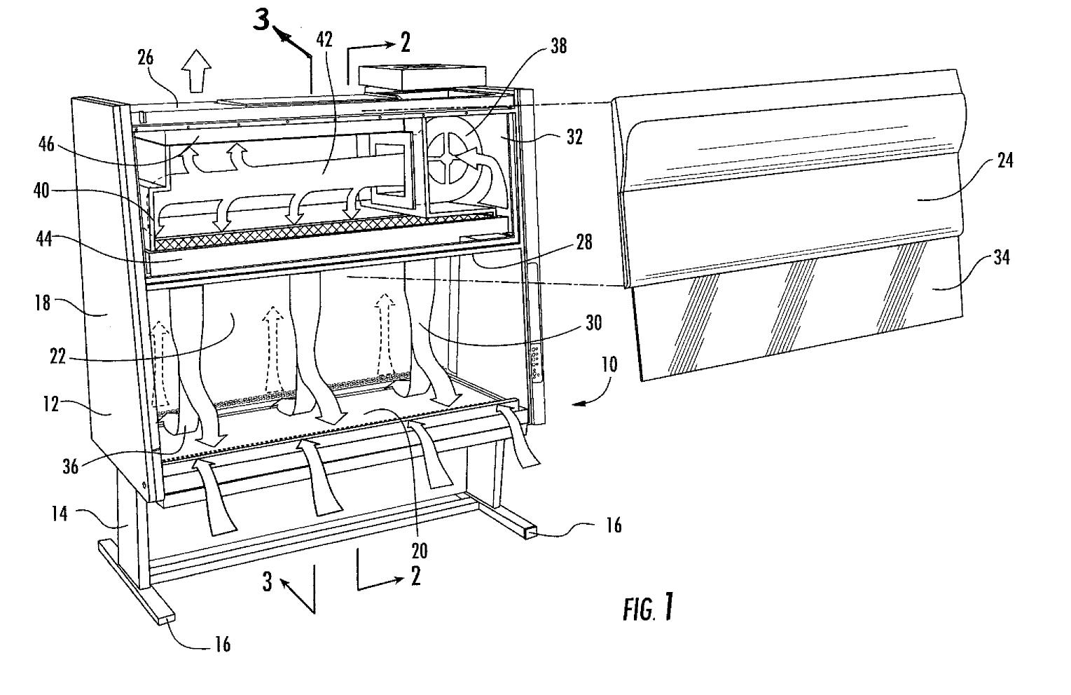

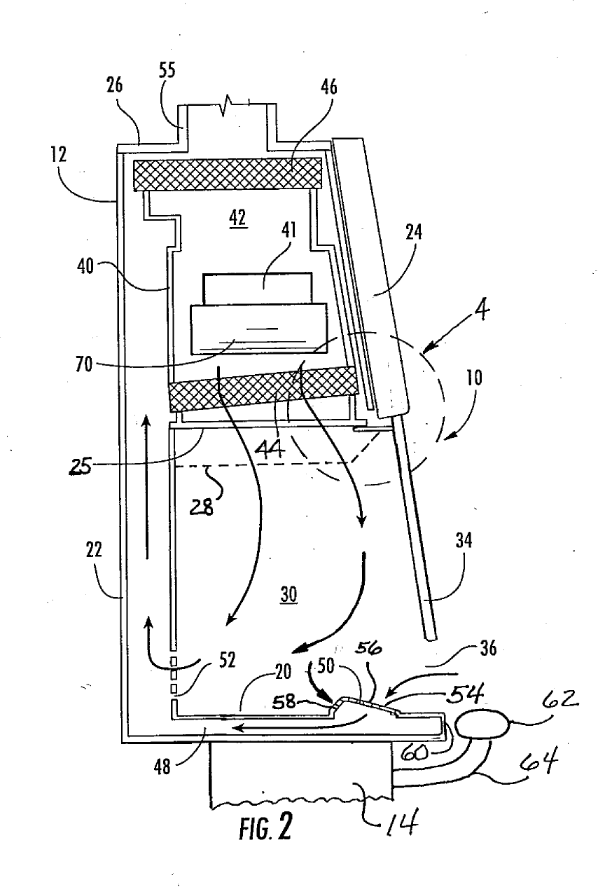

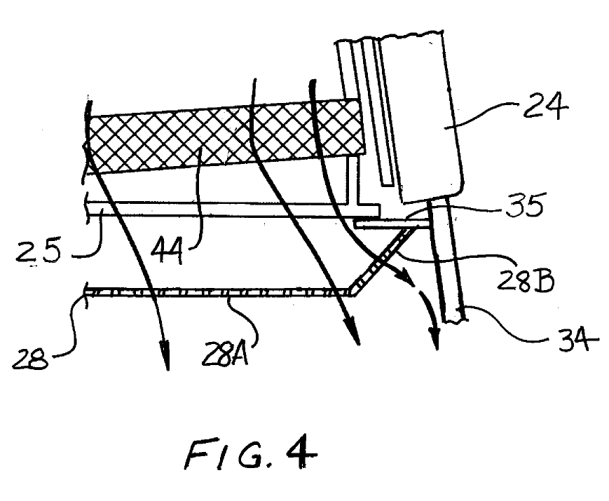

Referring now to the accompanying drawings, and initially to FIG. 1, a biological safety cabinet in accordance with one preferred embodiment of the present invention is indicated generally at 10. The safety cabinet 10 basically comprises a housing 12 supported on a trestle stand 14, which may include a set of casters 16 for moveability of the cabinet structure. The housing 12 is a generally rectangular structure having spaced-apart end walls 18, a bottom wall 20, a rear wall 22, a partial front wall 24, and a top wall 26, collectively defining an open interior which is divided by a horizontal intermediate filter structure 25, 28, 44 (see also FIGS. 2 and 4) into a lower work chamber 30 and an upper air recirculation chamber 32. The housing 12 may preferably be fabricated of sheet metal, such as stainless steel.

The partial front wall 24 predominately encloses only the air recirculation chamber 32, leaving open front access by users into the work chamber 30. A transparent sash 34 is supported by and extends downwardly from the front wall 24 to partially enclose the work chamber 30 except for a narrow front access opening 36 into the work chamber 30 between the bottom wall 20 and the lower edge of the sash 34 through which users may have manual access into the work chamber 30. The transparency of the sash 34 permits visual access into the work chamber 30 by users. The sash 34 may also be retractable as necessary to permit greater access into the work chamber 30 by users.

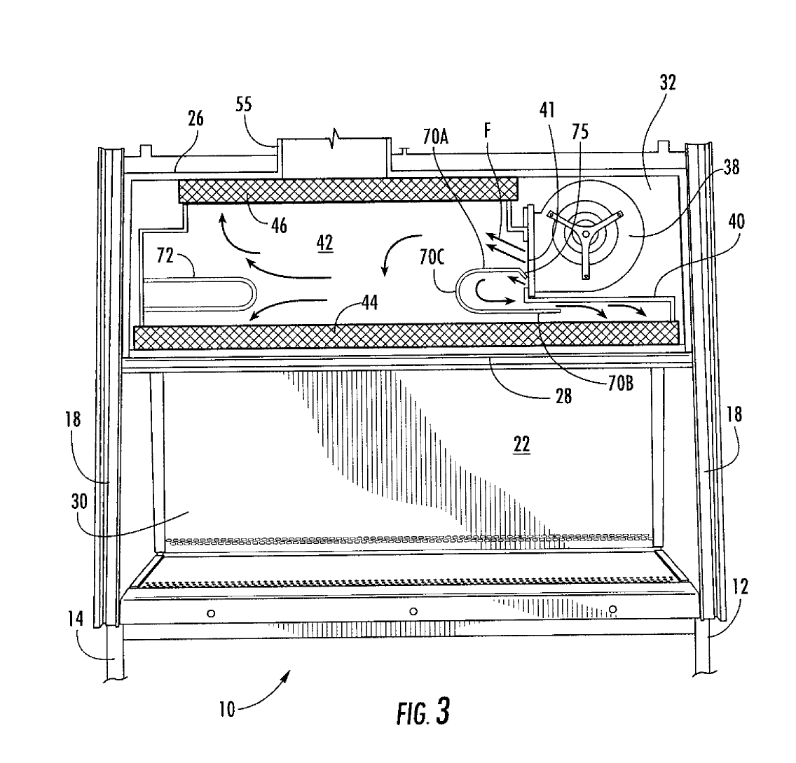

In FIG. 1, the front wall 24 is shown in exploded relation to the remainder of the cabinet 10 for illustration of the air recirculation chamber 32. As shown in FIG. 1 and further seen in FIG. 3, the majority of the air recirculation chamber 32 is occupied by a hollow sub-housing 40 the open interior of which serves as an air filtration chamber 42. An air circulation fan 38 is mounted within one end of the recirculation chamber 32 with the output side of the fan 38 mounted to one end of the sub-housing 40 to discharge blown air under positive pressurize into the air filtration chamber 42. The lowermost bottom side of the sub-housing 40 is open with a first air filter 44 affixed to the sub-housing in covering relation to the opening. Similarly, the uppermost topside of the sub-housing 40 is open with a second air filter 46 affixed to the sub-housing in covering relation to the opening. The two air filters 44, 46 are preferably high efficiency particulate air filters, more commonly referred to as HEPA filters, for their ability to capture molecular-sized microorganisms and like biological matter.

The intake side of the fan 38 draws air from within the work chamber 30 and also from the ambient air surrounding the safety cabinet 10 through hollow interior channels defined within the bottom and rear walls 20, 22 of the housing 12. More specifically, as best seen in FIG. 2, each of the bottom and rear walls 20, 22 are formed by dual spaced wall panels defining a continuous interior airflow channel 48 within the bottom wall 20 and continuing upwardly within the end and rear walls 18, 22, to open into the air recirculation chamber 32. A series of perforations 50 are formed along substantially the full length of the forward edge of the bottom wall 20 to open into the forwardmost end of the airflow channel 48. A similar series of perforations 52 are formed along the lowermost end of the rear wall 22 adjacent its juncture with the bottom wall 20, also opening into the airflow channel 48 thereat.

The housing 12 of the safety cabinet 10 will thus be understood to provide a controlled air recirculation system which operates as follows. The fan 38 continuously creates a negative pressure condition within its end of the air recirculation chamber 32 which acts through the airflow channel 48 to draw air from within the work chamber 30 through the perforations 52 and into the airflow channel 48. To a somewhat lesser extent, surrounding ambient air is drawn into the airflow channel 48 through the perforations 50. The fan 38 pressurizes the in-drawn air and discharges it under positive pressure into the filtration chamber 42 from which a portion of the air passes downwardly through the filter 44 into the work chamber and a portion of the air passes upwardly through the filter 46 into an exhaust 55. The filter 44 is of a substantially larger size than the filter 46 such that the majority of the airflow, preferably approximately 70%, returns into the work chamber 30 through the filter 44, with only a smaller proportion, preferably approximately 30%, of the airflow being exhausted. Within the work chamber 30, the air passing downwardly through the filter 44 moves predominantly vertically downwardly in a laminar manner which, together with the constraint of the sash 34, the constraint of incoming ambient air into the perforations 50, and the negative pressure exerted from the fan through the rearward perforations 52, substantially prevents the escape of any of the airflow outwardly through the access opening 36. Thus, users may perform laboratory procedures within the work chamber 30 utilizing hazardous substances, e.g., microorganisms, particulate toxic chemicals, etc., without risking escape of such substances into the ambient area outside the cabinet. Moreover, as such procedures are ongoing, the continuous recirculation of the air internally within the housing 12 progressively filters airborne contaminants so as to maintain sufficient cleanliness within the internal air to prevent contamination of the procedure.

To the extent thus far described, the basic structure and operation of the biological safety cabinet 10 is essentially conventional. In accordance with the present invention, the biological safety cabinet 10 is equipped with several air flow directional control enhancements effective to mitigate turbulent air currents and, in turn, to provide improved laminar air flow within the cabinet 10, thereby to mitigate ambient air ingress into and internal air escape from the work chamber 30.

More specifically, as best seen in FIG. 2, the air intake perforations 50 are formed in a perforated air intake grille 54 formed in the bottom wall 20 within the work chamber 30 at a small inward spacing from the forward access opening 36 and extending alongside the full length of the opening 36. A short flat unperforated portion of the bottom wall 20 extends forwardly between the grille 54 and the forward access opening 36. The grille 54 is of an asymmetrical angular configuration defined by a make-up air intake surface 56 and a recirculating internal air intake surface 58 each extending angularly upwardly from the bottom wall 20 in converging relation to one another. The make-up air intake surface 56 faces forwardly toward the access opening 36 at a more acute angle to the bottom wall 20 presenting a more elongated surface 56 than the surface 58 with a substantially greater number of perforations and surface area occupied by such perforations than the surface 58.

In this manner, the grille 54 provides several aerodynamic and other distinct advantages over ambient air intake designs of conventional biological safety cabinets. Specifically, conventional biological safety cabinets are known to have ambient air intakes wherein the openings or perforations are formed in the horizontally flat surface of the bottom surface of the work chamber. This design suffers the disadvantage that its flat configuration is less effective in insuring that incoming ambient air is drawn into the air recirculation system. In one known design of biological safety cabinet manufactured by ESCO Technologies (ASIA) PTE Ltd., of Singapore, the ambient air intake grille is of a symmetrical angularly raised configuration, but is located immediately at the forward access opening into the work chamber. This design suffer the disadvantage that its location necessarily tends to promote its use as an arm rest for technicians working within the cabinet, which typically causes a not insignificant number of the air intake openings to be covered and thereby to inhibit the intended air flow within the work chamber.

The angularly raised form of the grille 54 of the present invention orients the make-up air intake surface 56 into a forwardly facing relation to the access opening 36, to more reliably capture and direct the incoming ambient air into the channel 48 with lesser risk of any portion of the ambient air flow passing over the grille 54 into the work chamber 30. The angular configuration also defines a distinct physical separation of the make-up air intake surface 56 from the recirculating internal air intake surface 58 to better induce the recirculating internal air to flow only, or at least mainly, into the perforations of the surface 58 and the incoming ambient air to flow only, or at least mainly, into the intake surface 56, which assists in promoting and maintaining laminar internal air flow downwardly through the work chamber in the region of the access opening 36. The slight rearward spacing of the grille 54 from the forward access opening 36 provides a flat surface suitable for resting of a technician's wrists or forearms without obstructing, or at least with substantially lesser obstruction, of the perforations of the grille 54 so as not to inhibit its intended operation. The angular form of the grille 54 also deters users from placing any work materials, such as laboratory equipment or devices or biological materials, on the bottom wall of the work chamber adjacent the access opening, a not uncommon occurrence in conventional safety cabinets which risks accidental spillage or other cross-contamination through the access opening. Additionally, the forward end of the flat unperforated bottom wall section forwardly of the grille 54 forms a bullnose-like edge 60 against which the sash 34 may abut in a secure sealing manner when the sash is fully extended to fully close the work chamber, such as during disinfecting operations as may be performed by applying ultra-violet light within the work chamber.

As also seen in FIG. 2, the biological safety cabinet 10 includes a user arm rest 62 disposed immediately forwardly of the lowermost side of the access opening 36. The arm rest 62 is uniquely of an ellipsoidal cross-sectional configuration which contributes to the smooth non-turbulent aerodynamic flow of make-up air from the ambient room air toward and into the grille 54. Also, the arm rest 62 is mounted by a curved support arm 64 affixed to the trestle stand 14 rather than to the cabinet housing 12 to dispose the arm rest at a spacing from the housing 12. This mounting arrangement avoids a recognized concern in conventional biological safety cabinets, wherein arm rests are attached directly to the cabinet structure, that there is an elevated risk of cross-contamination between the arm rest and the work chamber and there is the need to disinfect periodically the arm rest along with the work chamber.

As best seen in FIG. 3, an arrangement of baffles 70, 72 is provided within the filtration chamber 42 to assist in channeling the incoming pressurized airflow from the fan 38 to the more remote regions of each filter 44, 46. The baffle 70 is mounted to the interior wall surface of the sub-housing 40 at the fan discharge opening 41 therein and has a main body which is of an overall curvilinear configuration comprised of two generally planar leg sections 70A, 70B connected by a curving intermediate connecting section 70C forming a generally parabolic-like shape. The upper leg section 70A of the baffle 70 is positioned immediately adjacent the fan discharge opening 41 and includes a short planar flange 75 projecting angularly from the leading end of the leg section 70A immediately adjacent the fan discharge opening 41 to be essentially parallel to the upward direction of the discharged airflow F from the fan 38. The baffle 70 is effective to partially divide the air stream discharged from the fan 38, causing the divided portion of the air stream to follow a reversed flow path into the narrow extent of the sub-housing 40 while permitting a portion of the discharged air stream to continue horizontally into the filtration chamber 42. The baffle 72 is mounted to the vertical wall of the sub-housing 40 most distally opposite the fan 38 and is of a symmetrically parabolic shape which assists in dividing the airflow reaching the distal region of the filtration chamber 42 to redirect a portion of the airflow upwardly toward the distal end of the filter 46 and another portion of the airflow downwardly toward the distal end of the filter 44.

In this manner, the baffles 70, 72 mitigate any tendency of the air to stagnate or become turbulent within the filtration chamber 42, thereby assisting in maintaining flow of the incoming air to the filters 44, 46. The two baffles 70, 72 thus cooperate in promoting a uniform movement and presentation of the airflow to each filter 44, 46 essentially across the full lengthwise and widthwise extent of each filter which promotes the desired laminar flow of air downwardly within the work chamber 30 substantially over its full lengthwise and widthwise extent to assist in optimizing the intended operative flow of air within the work chamber 30. The baffles 70, 72 also tend to reduce the noise generated by turbulence in the airflow within the filtration chamber 42.

According to a further aspect of the invention best seen in FIG. 4, the intermediate filter structure comprises a support frame portion 25 of the filter sub-housing 40, which serves as a mount for supporting the lower filter 44 transversely between the work chamber 30 and the filtration chamber 42, and a perforated grille 28 mounted across the housing 12 immediately below the lower filter 44 for transmission of filter circulating air downwardly into the work chamber. The perforated grille 28 has a generally flat main extent 28A extending horizontally across the housing 12 but terminating at a spacing from the sash 34 and an upwardly angled extent 28B inwardly adjacent the sash 34. A wiper element 35 extends between the filter support frame portion 25 and the grille 28 into sealing surface contact with the interior surface of the sash 34. The main extent 28A and the angled extent 28B of the grille 28 are formed with an array of multiple perforations for passage therethrough of internal air circulating through the filter 44 from the filtration chamber 42 into the work chamber 20. In particular, the angled extent 28B of the grille 28 is thereby effective to direct an increased flow of circulating internal air angularly forwardly and downwardly along the interior surface of the sash 34 to promote laminar flow of the circulating air therealong, as indicated by the directional arrows in FIG. 4.

As will be recognized by those persons skilled in the relevant field, the flow of air within the forward region of the work chamber 20 inwardly adjacent the sash 34 and downwardly therefrom inwardly adjacent the access opening 36 is critical, particularly in view of the differing air flow vectors that can prevail in this area. In a conventional biological safety cabinet, air passes only downwardly through and from the lower filter, resulting in a relatively weak flow of air in the forward region of the work chamber adjacent the sash. In turn, the continuing flow of air downwardly along the access opening can be less than optimal to prevent undesired inflow of ambient air. By contrast, the design of the grille 28 is effective to positively direct filtered air flow at and then along the sash 34. In particular, the angled orientation of the angled extent 28B of the grille 28 provides a substantial increase in the number of perforations per linear horizontal inch as compared to the main extent 28A of the grille to insure a greater quantity of air in the region along the sash 34. This more concentrated air flow insures not only a stronger and more positive movement of air downwardly along the sash but also, as a result, maintains the air flow moving in a laminar flow without migration of the air leftward or rightward.

It will therefore be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A biological safety cabinet comprising:
(a) a housing defining a work chamber, a filtration chamber, and a forward opening into the work chamber for user access,
(b) an air recirculation system for circulating internal air within and between the work chamber and the filtration chamber in a controlled manner for mitigating escape of circulating internal air from the work chamber and for mitigating ingress of ambient air into the work chamber through the forward opening, the air recirculation system including a filter between the filtration chamber and the work chamber for removing contaminants from the air before re-entering the work chamber,
(c) a stand for support thereon of the housing at an elevation suitable for user access into the work chamber through the forward opening, and
(d) a user arm rest affixed to the support stand and extending alongside the forward opening at a spacing outwardly from the housing.

2. A biological safety cabinet according to claim 1, wherein the air recirculation system includes an air exhaust sub-system for discharge of a portion of the internal air from the filtration chamber and an air intake sub-system for directing make-up ambient air into the filtration chamber for replacement of the exhausted internal air, the air intake sub-system including an intake opening disposed adjacent the forward opening, the arm rest being disposed adjacent the air intake opening at an outward spacing therefrom.

3. A biological safety cabinet according to claim 2, wherein the arm rest has an aerodynamic configuration for assisting in direction of ambient make-up air to the air intake opening.

4. A biological safety cabinet according to claim 3, wherein the arm rest is of a generally elliptical shape.

5. A biological safety cabinet according to claim 1, wherein the housing including a transverse air transmission grille between the work chamber and the filtration chamber and a sash forwardly and downwardly of the grille for defining a forward boundary to the work chamber, and wherein the grille has a generally flat main extent terminating at a spacing from the sash and an upwardly angled extent adjacent the sash, the main extent and the angled extent of the grille being perforated for passage of internal air circulating through the filter from the filtration chamber into the work chamber, the angled extent of the grille being effective to direct an increased flow of circulating internal air downwardly along the sash to promote laminar flow of the circulating air therealong.

6. A biological safety cabinet according to claim 2, wherein the air recirculation system includes a perforated air intake grille disposed within the work chamber inwardly spaced from the forward opening by a flat unperforated wall section, the grille having an asymmetrical angular configuration defining a make-up air intake surface and an internal air intake surface oriented angularly upwardly in converging relation to one another with the make-up air intake surface in forward facing relation to the forward opening for intake therethrough of ambient make-up air and with the internal air intake surface facing rearwardly away from the forward opening for intake therethrough of circulating internal air moving downwardly through the work chamber, and wherein the flat unperforated wall section may serve as an arm rest area.

7. A biological safety cabinet according to claim 6, wherein the housing including a transverse air transmission grille between the work chamber and the filtration chamber and a sash forwardly and downwardly of the grille for defining a forward boundary to the work chamber, and wherein the grille has a generally flat main extent terminating at a spacing from the sash and an upwardly angled extent adjacent the sash, the main extent and the angled extent of the grille being perforated for passage of internal air circulating through the filter from the filtration chamber into the work chamber, the angled extent of the grille being effective to direct an increased flow of circulating internal air downwardly along the sash to promote laminar flow of the circulating air therealong.

8. A biological safety cabinet comprising:
(a) a housing defining a work chamber, a filtration chamber, and a forward opening into the work chamber for user access,
(b) an air recirculation system for circulating internal air within and between the work chamber and the filtration chamber in a controlled manner for mitigating escape of circulating internal air from the work chamber and for mitigating ingress of ambient air into the work chamber through the forward opening, the air recirculation system including a filter between the filtration chamber and the work chamber for removing contaminants from the air before re-entering the work chamber,
(c) the housing including a transverse air transmission grille between the work chamber and the filtration chamber and a sash forwardly and downwardly of the grille for defining a forward boundary to the work chamber, and
(d) the grille having a generally flat main extent terminating at a spacing from the sash and an upwardly angled extent adjacent the sash, the main extent and the angled extent of the grille being perforated for passage of internal air circulating through the filter from the filtration chamber into the work chamber, the angled extent of the grille being effective to direct an increased flow of circulating internal air downwardly along the sash to promote laminar flow of the circulating air therealong.

9. A biological safety cabinet comprising:
(a) a housing defining a work chamber, a filtration chamber, and a forward opening into the work chamber for user access,
(b) an air recirculation system for circulating internal air within and between the work chamber and the filtration chamber in a controlled manner for mitigating escape of circulating internal air from the work chamber and for mitigating ingress of ambient air into the work chamber through the forward opening, the air recirculation system including
(i) a filter between the filtration chamber and the work chamber for removing contaminants from the air before re-entering the work chamber,
(ii) an air exhaust sub-system for discharge of a portion of the internal air from the filtration chamber,
(iii) an air intake sub-system for directing make-up ambient air into the filtration chamber for replacement of the exhausted internal air, and
(iv) a perforated air intake grille disposed within the work chamber inwardly spaced from the forward opening by a flat unperforated wall section, the grille having an asymmetrical angular configuration defining a make-up air intake surface and an internal air intake surface oriented angularly upwardly in converging relation to one another with the make-up air intake surface in forward facing relation to the forward opening for intake therethrough of ambient make-up air and with the internal air intake surface facing rearwardly away from the forward opening for intake therethrough of circulating internal air moving downwardly through the work chamber, and wherein the flat unperforated wall section may serve as an arm rest area.
